(19) United States
(12) Patent Application Publication
(10) Pub. No.: US 2012/0317132 A1
(43) Pub. Date: Dec. 13, 2012

(54) Instance-Based Command Execution, Approval, and Notification Framework

(75) Inventors: Shane Brady, Seattle, WA (US); Linden Goffar, Snohomish, WA (US); Vladimir Grebenik, Redmond, WA (US); Andrey Lukyanov, Redmond, WA (US); Rajmohan Rajagopalan, Redmond, WA (US)

(73) Assignee: Microsoft Corporation, Redmond, WA (US)

(21) Appl. No.: 13/154,660

(22) Filed: Jun. 7, 2011

(51) Int. Cl. G06F 3/048; G06F 17/30

(52) U.S. Cl. 707/769; 715/764; 707/E17.014

(57) ABSTRACT

An action approval framework may be provided. Upon receiving a selection of an action and at least one action parameter from a user, the requested action may be evaluated to determine if that action requires approval. Once the required approval has been received, or if the action may be automatically approved, the requested action may be performed.

### RELATED APPLICATIONS

Related U.S. patent application Ser. No. 13/052,788, filed on Mar. 21, 2011 and entitled “Email-Based Automated Recovery Action in a Hosted Environment,” assigned to the assignee of the present application, is hereby incorporated by reference

### BACKGROUND

An interface-based command framework may allow for the automation of approval and execution of user-requested commands. In some situations, engineers and operators are typically allowed to perform only certain read-only operations in the hosted environment in order to minimize service disruptions. When a service incident occurs, however, engineers are not allowed to perform certain automated recovery actions in the environment by an automation framework. Conventional systems often require an approver/administrator to approve a static set of commands for a given user or group of users.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

An action approval framework may be provided. Upon receiving a selection of an action and at least one action parameter from a user, the requested action may be evaluated to determine if that action requires approval. Once the required approval has been received, or if the action may be automatically approved, the requested action may be performed.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing command execution approval; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Hosted computed environments, such as datacenters, often rely on a high level of automation to provide a high level of service availability and a high level of security that prevents customer data to be exposed to any third parties. Nevertheless, in some cases manual actions by designated support users may be required to restore service availability. The problem is that these manual actions should not compromise customer data security and service availability in case of support user error or intentional misconduct.

A support user (i.e., a requestor) may be provided with a consistent grammar to execute requested actions with the help of asynchronous automation system. The command may be executed automatically if the requestor has prior approval to use it. If not, the system may seek the approval from an approver and execute the command on the requestor's behalf, based on the approver's decision. Notifications may also be provided to a relevant set of users for each command execution.

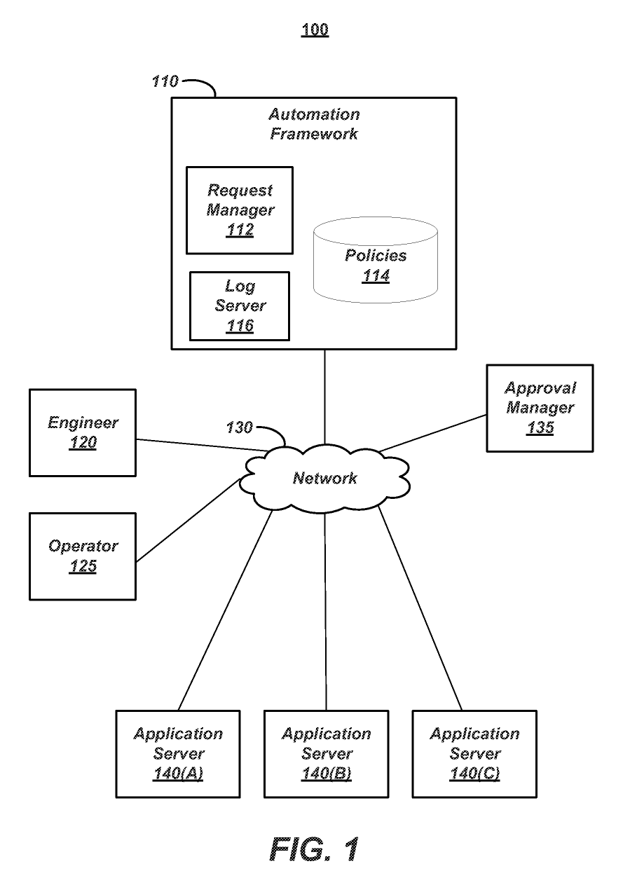

FIG. 1 is a block diagram of an operating environment 100 comprising an automation framework 110. Automation framework 110 may comprise a request manager 112, a policy database 114, and a log server 116. Automation framework 110 may receive action requests formatted in a standardized grammar from an engineer 120 and/or an operator 125 (i.e., support users) via a network 130. Action requests may be submitted, for example, via email and/or a request portal on a website. Action requests may be evaluated by request manager 112 against policy database 114. Approval requests may then be sent to an approval manager 135. Upon receiving an approval or denial of the request from approval manager 135, the result may be reported to log server 116. If the action request is approved, the action may be performed on one or more of a plurality of application servers 140(A)-(C). Policies stored in policy database 114 may be organized, for example, according to the schema illustrated in Table 1, below.

TABLE 1

| Property | Type | Description |
|---|---|---|
| Name | varchar | Policy name |
| Description | varchar | Policy description |
| Role | varchar | User role this policy is mapped to |
| AuthorityRank | int | Policy authority rank. Higher ranking policy |
| | | requires more authoritative approvers. If the |
| | | same request can be approved by two |
| | | policies the policy with lower |
| | | authoritative rank will be used. |
| RotationTeam | varchar | Rotation team name in Escalation DB. This |
| | | will be used to get current rotation |
| | | team contacts from Escalation DB. |
| SecurityGroup | varchar | Security group name that contains |
| | | approvers that are authorized to approve change |
| | | requests in this policy. |

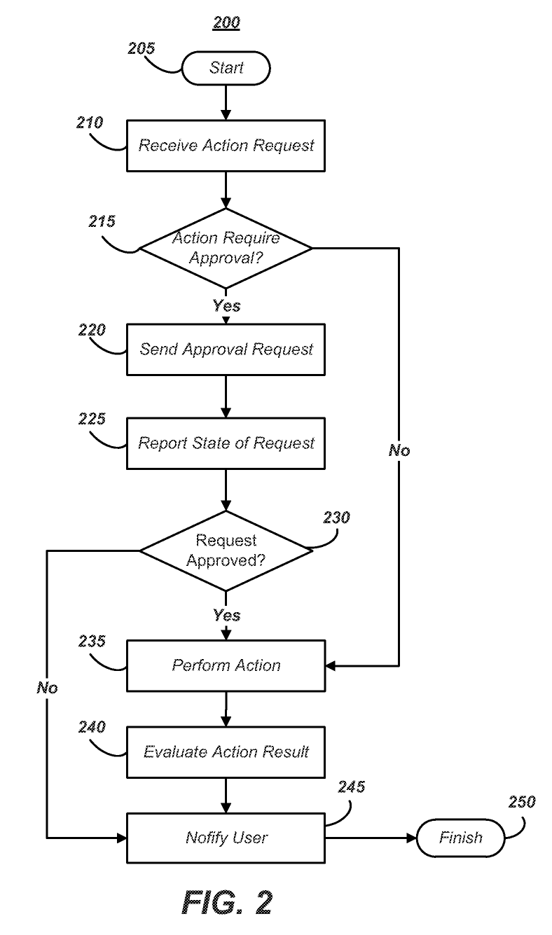

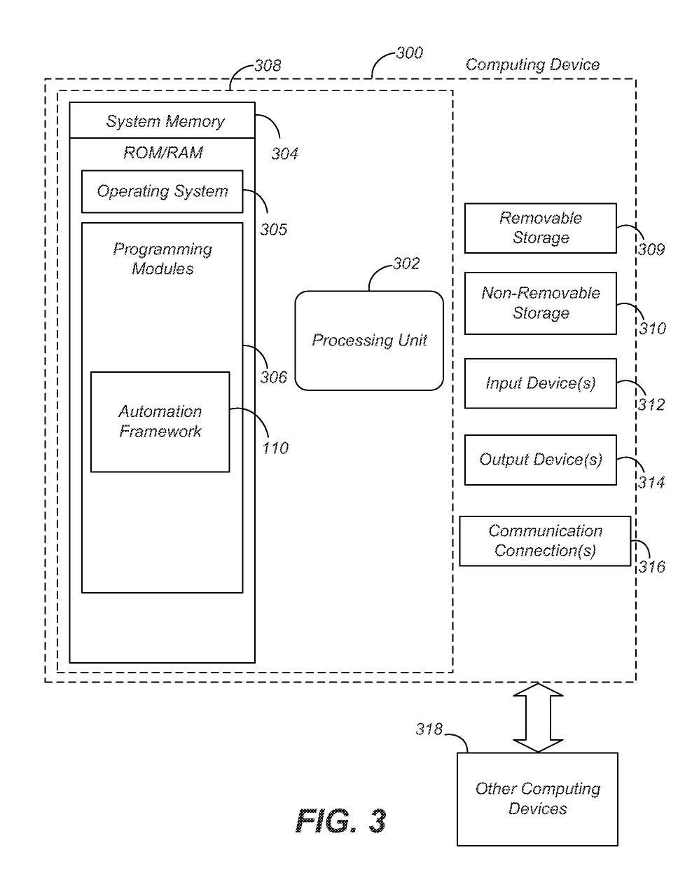

FIG. 2 is a flow chart setting forth the general stages involved in a method 200 consistent with an embodiment of the invention for providing an action approval framework. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may receive an action request from a user. For example, the first user may comprise operator 125 or engineer 120 who may select an action from a list of available actions, such as may be displayed on a web page. Consistent with embodiments of the invention, the user may submit a request, such as by email, using a predefined grammar comprising a command and associated parameters (e.g., “restart server001”).

From stage 210, method 200 may advance to stage 215 where computing device 300 may determine whether the requested action requires approval. For example, automation framework 110 may determine whether operator 125 has been pre-approved to execute the requested action, or whether the action does not require approval. Each user group may comprise a set of permissions recorded in policy database 114 that may control what actions the users associated with that group may perform with and/or without approval. For example, users belonging to an operator user group may be allowed to read log entries associated with application servers 140(A)-(C) but may not be allowed to start or stop those services. Consistent with embodiments of the invention, different users and/or groups may have different permissions for different application servers. Users belonging to an administrative user group may have elevated permissions, including the ability to perform actions that may result in service disruptions.

If, at stage 215, computing device 300 determines that the user does not have permission to perform the action, method 200 may advance to stage 220 where computing device 300 may send an approval request to at least one second user. For example, the approval request may comprise a problem summary received from the first user and/or a standardized command text associated with the requested action.

Automation framework 110 may send the approval request via email over network 130 to approval manager 135. The approving user may be identified according to a policy stored in policy database 114 and associated with the requested action and/or the requesting user. For example, an approver may be associated with all requests to restart a particular server and/or the requesting user may have their approvals routed to their manager.

Method 200 may then advance to stage 225 where computing device 300 may receive a query as a current state of the request and report that current state. For example, the requesting user may refresh a web page displaying a list of recently requested actions, and the current status (e.g., approval requested, approval granted, action in process, action complete, etc.) may be displayed to that user. Approvers and/or administrators may also query the state of a given and/or a plurality of requested action(s).

Method 200 may then advance to stage 225 where computing device 300 may determine whether the requested action is approved. For example, approval manager 135 may reply to the email approving or denying the request. For another example, approval manager 135 may simply select a user interface control associated with the email message indicating whether they approve or deny the request, much as a meeting request may be accepted or rejected. Certain actions may be pre-approved for the requesting user, as applied by a relevant policy and/or a user may retain approval to re-issue the same command within a configurable time window (e.g., one hour).

After determining that the action has been approved at stage 230, or if no approval was determined to be needed at stage 215, method 200 may then advance to stage 235 where computing device 300 may perform the requested action. For example, automation framework 110 may execute a requested restart action on application server 140(A).

After performing the action at stage 235, method 200 may advance to stage 240 where computing device 300 may evaluate a result of performing the requested action. For example, automation framework 110 may determine if an executed restart command successfully restarted a target server.

After evaluating the action performance at stage 240, or if the request was denied at stage 230, method 200 may advance to stage 245 where computing device 300 may notify the user. For example, automation framework 110 may send an email to the requesting user informing them that the action has been executed and providing a report of the result. Method 200 may then end at stage 250.

An embodiment consistent with the invention may comprise a system for providing an action approval framework. The system may comprise a memory storage and a processing unit coupled to the memory storage. The processing unit may be operative to receive a selection of an action from a user, receive an input of at least one action parameter from the user, and determine whether the requested action requires approval. In response to determining that the requested action requires approval, the processing unit may be operative to determine whether the requested action is approved; and in response to determining that the requested action is approved, perform the requested action.

Another embodiment consistent with the invention may comprise a system for providing an action approval framework. The system may comprise a memory storage and a processing unit coupled to the memory storage. The processing unit may be operative to receive a selection of an action from a user from a plurality of available actions, determine whether the requested action is approved, and, in response to determining that the requested action has been approved, perform the requested action, evaluate at least one result of performing the requested action, and notify the user of the at least one result.

Yet another embodiment consistent with the invention may comprise a system for providing an action approval framework. The system may comprise a memory storage and a processing unit coupled to the memory storage. The processing unit may be operative to receive a selection of an action from a listed plurality of available actions, determine whether the selected action requires approval according to an administrative policy, and, in response to determining that the requested action requires approval according to the administrative policy, request an approval of the action from the approving user associated with the requested action. The processing unit may be further operative to receive a query as to a current state of the requested action and report the current state of the requested action. The processing unit may be further operative to determine whether the approval of the action has been received, and, in response to determining that the approval of the action has been received, perform the requested action, evaluate at least one result of performing the requested action, and notify the user of the at least one result.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise operating environment 100 as described above. Methods described in this specification may operate in other environments and are not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g., random access memory (RAM)), non-volatile (e.g., read-only memory (ROM)), flash memory, or any combination. System memory 304 may include operating system 305, one or more programming modules 306, and may include request manager 112. Operating system 305, for example, may be suitable for controlling computing device 300's operation. In at least some embodiments, programming modules 306 may include request manager 112 and/or log server 116. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 304, including operating system 305. While executing on processing unit 302, programming modules 306 (e.g., request manager 112) may perform processes including, for example, one or more of method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing an action approval framework, the method comprising:
receiving a selection of an action from a user;
receiving an input of at least one action parameter from the user;
determining whether the requested action requires approval;
in response to determining that the requested action requires approval, determining whether the requested action is approved; and
in response to determining that the requested action is approved, performing the requested action.

2. The method of claim 1, further comprising notifying the user.

3. The method of claim 2, wherein the user comprises a support user.

4. The method of claim 1, further comprising notifying at least one other user.

5. The method of claim 1, further comprising logging the performance of the requested action.

6. The method of claim 1, further comprising:
evaluating an effect of performing the requested action; and
logging the evaluated effect.

7. The method of claim 1, wherein the requested action is selected from a list of available actions.

8. The method of claim 7, wherein each of a plurality of entries on the list indicates whether approval will be required.

9. The method of claim 8, wherein each of the plurality of entries on the list indicates an identity of an associated approval manager.

10. The method of claim 1, further comprising determining whether all required parameters associated with the requested action have been received.

11. The method of claim 10, further comprising:
in response to determining that all required parameters associated with the requested action have not been received, prompting the user for at least one missing parameter.

12. A computer-readable medium which stores a set of instructions which when executed performs a method for providing an action approval framework, the method executed by the set of instructions comprising:
receiving a selection of an action from a user from a plurality of available actions, wherein at least one first action of the plurality of available actions does not require approval, at least one second action of the plurality of available actions has been pre-approved for the user, and at least one third action of the plurality of available actions requires an approval;
determining whether the requested action is approved;
in response to determining that the requested action has been approved, performing the requested action;
evaluating at least one result of performing the requested action; and
notifying the user of the at least one result.

13. The computer-readable medium of claim 12, further comprising identifying an approver of the requested action according to an administrative policy.

14. The computer-readable medium of claim 13, wherein the administrative policy specifies the approver according to the requested action.

15. The computer-readable medium of claim 13, wherein the administrative policy specifies the approver according to the requesting user.

16. The computer-readable medium of claim 13, further comprising:
determining whether the administrative policy identifies at least one second user to be notified in response in association with the requested action; and
in response to determining that the administrative policy identifies the at least one second user to be notified in response in association with the requested action, notifying the at least one second user.

17. The computer-readable medium of claim 12, further comprising:
receiving a query as to a current state of the requested action; and
reporting the current state of the requested action.

18. The computer-readable medium of claim 17, wherein the query is received from the user.

19. The computer-readable medium of claim 17, wherein the query is received from an approver.

20. A system for providing an action approval framework, the system comprising:
a memory storage; and
a processing unit coupled to the memory storage, wherein the processing unit is operative to:
receive, from a support user, a selection of an action from a listed plurality of available actions, wherein at least one of the plurality of available actions is associated with an indicator identifying whether the action requires approval and at least one identifier associated with an approving user,
determine whether the selected action requires approval according to an administrative policy,
in response to determining that the requested action requires approval according to the administrative policy, request an approval of the action from the approving user associated with the requested action,
receive a query as to a current state of the requested action,
report the current state of the requested action,
determine whether the approval of the action has been received,
in response to determining that the approval of the action has been received, perform the requested action,
evaluate at least one result of performing the requested action, and
notify the user of the at least one result.
